(19) United States
(12) Patent Application Publication
(10) Pub. No.: US 2004/0199778 A1
(43) Pub. Date: Oct. 7, 2004

(54) Method and system for increasing the accuracy and security of data capture from a paper form

(76) Inventors: Paul G. Wernet, Annandale, VA (US); Dean Joseph Whitmore, Alexandria, VA (US)

Correspondence Address: BIRCH STEWART KOLASCH & BIRCH, PO BOX 747, FALLS CHURCH, VA, 22040-0747, US

(21) Appl. No.: 10/478,129

(22) PCT Filed: May 21, 2002
(86) PCT No.: PCT/US02/15948

Related U.S. Application Data
(60) Provisional application No. 60/291,944, filed on May 21, 2001.

(51) Int. Cl. H04L 9/00

(52) U.S. Cl. 713/189

(57) ABSTRACT

A system and method dynamically generates and prints an encrypted two-dimensional barcode on a electronic form intended for data entry. A field set is specified to identify the data that will be encrypted within the two-dimensional barcode. A password and specified and is used to encrypt the data; and form identification information is also provided identifying the form electronically when it is submitted and scanned (9). A two-dimensional barcode is dynamically generated when an end user (7) prints the form (8), such that the data content of the two-dimensional barcode is the data entered into the form by the end user. The two-dimensional barcode is printed with the form, such that when the user requests printing, the data and field identification information from each field in the selected field set is extracted, the data and field identification information is encrypted with the specified encryption password, the identifying information is included, but not encrypted, and the printed two-dimensional barcode contains both the encrypted information and the unencrypted identifying information.

### FIELD OF THE INVENTION

This invention relates in general to computer software, and in particular to a method and system for increasing the accuracy and security of data capture from a paper form where the form was completed electronically and printed out prior to submission. The invention utilizes two-dimensional barcode technology to dynamically capture data entered electronically into the form. The data contained in this two-dimensional barcode is then encrypted for security and authentication purposes and printed on the form when the user prints the form. When the printed form is received by the Data Collector at a central processing site, the two-dimensional barcode is scanned and decrypted, the form is authenticated, and the data is extracted virtually error-free.

### BACKGROUND OF THE INVENTION

Electronic forms applications consist of three primary components: design software for the Form Author, filler software for the End-User completing the form, and server software for the Form Distributor and/or Data Collector (the Form Distributor and the Data Collector may or may not be the same entity, and either may or may not be related to the Form Author).

The design software is used to create the electronic form (e-form), or user interface of the data container, as well as the algorithms associated with the e-form and data to be entered into the e-form. The Form Author may design the e-form as a traditional electronic form or integrate elements of hypertext markup language (HTML), extensible markup language (XML), portable document format (PDF), graphic elements (e.g., GIF, TIF. JPEG) and other objects to achieve the desired user interface. The designer may also specify data edits, validation, and other functions such as encryption, glyph generation, e-mail routing information, etc. that govern the behavior of the e-form in the filler application.

Filler software allows End Users to view and interact with the e-forms created using the design software. User interactions include filling out the e-form electronically, saving the e-form, printing the e-form, submitting the e-form, and similar functions depending on the algorithms associated with the e-form by the designer.

Server software allows form distributors and Data Collectors to process forms (e-forms and paper forms) automatically. For e-forms, the server software enables the Form Distributor to pre-fill forms with data from a database and distribute the pre-filled forms to End Users electronically (e.g., via email). Optionally, the distributor may encrypt the pre-filled data, or subsets of the pre-filled data, prior to distributing the e-forms. Server software also enables Data Collectors to process incoming e-forms electronically and automatically. An example of such processing would be to receive the incoming e-form, identify the form, authenticate the form, decrypt the form, extract the data from the form, and write the data to a database. For paper forms, the server software enables Data Collectors to automatically extract the form data from the paper form by scanning a two-dimensional barcode containing the form data, decrypt the data extracted from the bar code, authenticate the form, and write the extracted data to a database.

Prior to this invention, if a Data Collector required the End User to submit the form on paper (as is the case if the form requires a ‘wet’ signature), the Data Collector had to rely on OCR/ICR/OMR, re-keying, or some other method to extract the data from the paper form. These data extraction methods are prone to transcription errors, are costly, and cannot detect counterfeit forms. This invention allows Data Collectors to receive the printed form (with the ‘wet’ signature) and extract the data by scanning a two-dimensional barcode printed on the form. This method is more accurate than prior data extraction methods, because scanning a two-dimensional barcode is an all-or-nothing proposition: either it scans correctly, and the data is extracted exactly as it was entered into the form; or it doesn't scan at all, so no data errors are introduced via the scanning process (the form would have to go to exception processing instead). It is also more secure, since the data in the printed two-dimensional barcode is encrypted, ensuring that only an authorized party (such as the Data Collector) can extract the data electronically.

Counterfeit forms are not a new concept, but their likely frequency and the damage they can wreak on Data Collectors are dramatically increased in the world of PC-rendered paper forms (i.e., where, forms are obtained electronically by an End User and printed out by the End User before submission to the Data Collector). This scenario presents risks to the Data Collector, since a knowledgeable End User could conceivably alter a form before submitting it (either electronically or printed on paper). For example, using form design tools, an End User could change the perjury statement common to many forms to read as follows: “I do NOT declare under penalty of perjury . . . ”. The simple insertion of the word NOT in the perjury statement clearly violates the intention of the Data Collector. It then becomes a further obligation on the Data Collector to validate the authenticity of the submitted forms themselves, not just the data included on those forms. However, with this invention, the data imbedded in the two-dimensional bar code can only be successfully decrypted by an entity with the correct Form Lock password, or keyset. If the data cannot be decrypted with the correct Form Lock password, then the Data Collector or other authorized entity knows the form itself is counterfeit. The same is true for an electronic form submission, since the Data Collector will only be able to decrypt the data on the form if the original Form Lock password functions.

### SUMMARY OF THE INVENTION

The present invention disclosed herein comprises a method and system for increasing the accuracy and security of data capture from a paper form where the form was completed electronically and printed out on paper prior to submission, and in authenticating the printed form. The invention utilizes two-dimensional barcode technology to dynamically capture data entered electronically into the form. This two-dimensional barcode is then encrypted for security and printed on the form when the user prints the form. When the printed form is received by the Data Collector, the two-dimensional barcode is scanned and decrypted, and the data is extracted virtually error-free, eliminating the need for more costly, less efficient data extraction technologies and techniques. Successful decryption of the data authenticates the form as well, since the decryption will fail if the form has been altered or otherwise tampered with.

### DETAILED DESCRIPTION OF THE DRAWINGS

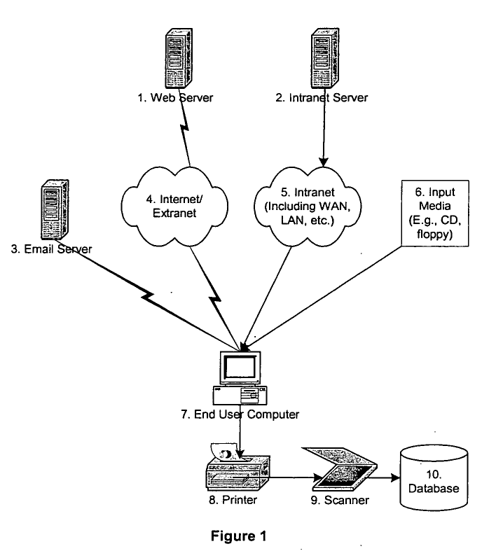

Referring to FIG. 1, there is depicted a graphic representation of a data processing system which may be utilized to implement the present invention. As may be seen, data processing system may include a plurality of networks, such as Local Area Network (LAN), Wide Area Network (WAN) and Internet, each of which may include a plurality of individual computers respectively. Those skilled in the art will appreciate that a plurality of workstations coupled to a host processor may be utilized for each such network. As is common in such data processing systems, each individual computer may be coupled to a storage device and/or printer/output device and/or input device.

The data processing system may also include multiple server computers, such as mainframe computer, which may be coupled to computer, LAN, WAN or Internet by means of communications link. The server computers may also be coupled to a storage device which may serve as remote storage for the End User computer, LAN, WAN or Internet. Similarly, the End User computer, WAN and Internet may be coupled via communications link through a subsystem control unit/communications controller and communications link to a gateway server creating an inter-network link.

With respect to the End User computer, LAN, WAN and Internet, a plurality of documents or resource objects may be stored within storage device and controlled by a server computer, as resource manager or library service for the resource objects thus stored. Those skilled in the art will appreciate that the server computer may be located a great geographic distance from LAN and similarly, LAN may be located a substantial distance from the End User computer. For example, the End User computer may be located in Colorado while LAN may be located in Washington and server computer may be located in New York.

Software program code which employs the present invention is typically stored in the memory of a storage device of a stand alone work station or storage device of a server computer from which a developer may access the code. For distribution purposes, the software program code may be embodied on any of a variety of known media for use with a data processing system, such as a diskette or CD-ROM or may be distributed to users from the memory of one computer system over a network of some type to other computer systems for use by users of such other systems. Such techniques and methods for embodying software code on media and/or distributing software code are well known and will not be further discussed herein.

With respect to the present invention, the End User uses the End User computer 7 to access the e-form. The End User computer is running software program code which employs the present invention. The e-form is accessed directly from a storage device connected to the End User computer 7, such as a local hard drive, or from some form of input media 6, or from an email message from an email server 3, or from a communications link to the Internet/Extranet 4 and web server 1, or from a local Intranet 5 and Intranet server 2 or some similar access method. The End User uses the End User computer 7 to view the eform, fill in data in the data fields, save the form, and to perform other similar actions. When the eform is completed and the End User prints the eform to the printer 8, the End User computer 7 carries out the instructions in the software program code which employs the present invention, dynamically creates the encrypted data set from the field data contained in the eform and prints the encrypted data along with identifying information in a two-dimensional barcode on the paper document. The printed document is then sent to the Data Collector. When the Data Collector receives the printed document, the document is scanned using scanner 9 which is attached to a scanning station. The scanning station is running software program code which employs the present invention to decipher the two dimensional barcode and process the data appropriately (identifying the originating form, authenticating the form, decrypting the encrypted data set, identifying the correct database, and writing the data to the database 10). Once processed, the data may be written to a database 10 or some other storage device or passed to another system or application for continued processing or other purposes.

### DETAILED DESCRIPTION OF THE INVENTION

When the e-form is being designed using the designer software, the designer selects a set of fields on the e-form for creating the dynamic two-dimensional barcode (the 2D barcode field set). This set of fields can include all of the fields on the form or only a selected subset of fields on the form. The designer also selects an encryption password that will be used to encrypt the data in the 2D barcode field set before it is printed on the paper form as a two-dimensional barcode. An example of a common two-dimensional barcode, the PDF417, appears below:

When the End User opens the e-form in the filler software, the End User can enter data via PC keyboard and mouse selections into the data fields electronically (e.g., type in the data; click on pull-down menus to select specific item(s)). When the user is done filling out the form, the user can print the form. When the user clicks the print button (or icon), the filler software automatically extracts the data from the 2D barcode field set, encrypts the data, and prints a two-dimensional barcode containing the encrypted data onto the paper form. The printed two-dimensional barcode also contains some unencrypted data (e.g., form ID number, registration number, or similar identifying information) that is used to identify the form when it is returned to the Data Collector. This process is transparent to the End User, except that the End User will see a two-dimensional barcode printed on the form. The End User may then submit the printed form to the Data Collector.

When the Data Collector receives the printed form, the Data Collector may scan the two-dimensional barcode printed on the form to extract the form data electronically. This is done using a conventional two-dimensional barcode scanner and the server software. The scanner scans the barcode and extracts the encrypted field data from the barcode. The server software identifies the originating e-form based on non-encrypted data included in the two-dimensional barcode. The server software then applies the registered keyset associated with the e-form identification information to decrypt the encrypted field data. Successful decryption of the dataset in the barcode authenticates the form. After the data is decrypted it is written to a database.

We claim:

1. A method of dynamically generating and printing an encrypted two-dimensional barcode containing the data entered into an electronic form, which comprises:
specifying the field set to identify the data that will be encrypted and contained in the two-dimensional barcode;
specifying the names of the fields in the field set, so that the fields can be made to correspond to fields in a database associated with the form;
including the field names or other identifying information along with the field content for each selected field in the field set, such that each field name and the respective field content are and remain associated with each other;
specifying the encryption password that will be used to encrypt the data;
specifying the form identification information, that will be included in the two-dimensional barcode but not encrypted, to identify the form electronically when it is submitted and scanned;
dynamically generating the two-dimensional barcode when the End User prints the form, such that the data content of the two-dimensional barcode is the data entered into the form by the End User;
dynamically generating the two-dimensional barcode when the End User prints the form, such that when the user clicks the print button, the data and field identification information from each field in the selected field set is extracted, the data and field identification information is encrypted with the specified encryption password, the identifying information is included, but not encrypted, and the two-dimensional barcode containing both the encrypted information and the unencrypted identifying information is printed on the form.

2. A method of automatically extracting data from a printed, encrypted two-dimensional barcode, which comprises the steps of:
scanning the two-dimensional barcode with a conventional two-dimensional barcode scanner;
identifying the originating electronic form based on the unencrypted identifying information included in the two-dimensional barcode;
retrieving the specified encryption keyset to decrypt the data contained in the two-dimensional barcode based on properly identifying the originating electronic form;
decrypting the encrypted data contained in the two-dimensional barcode using the specified encryption password;
authenticating the dataset as having originated from the originating form based on the success or failure of the decryption process;
identifying the correct database to write the data to based on properly identifying the originating electronic form, which is associated with a specific database;
writing the decrypted data to the specified database, such that the field data from the form is written to the appropriate field(s) in the database as defined by the field names from the form and the associated database fields.

3. A method of authenticating a printed version of an electronic form from a printed, encrypted two-dimensional barcode, which comprises the steps of:
scanning the two-dimensional barcode with a conventional two-dimensional barcode scanner;
identifying the originating electronic form based on the unencrypted identifying information included in the two-dimensional barcode;
retrieving the specified encryption keyset to decrypt the data contained in the two-dimensional barcode based on properly identifying the originating electronic form;
decrypting the encrypted data contained in the two-dimensional barcode using the specified encryption password;
authenticating the printed form as the printed product of the original electronic form based on the success or failure of the decryption process.
